(19) United States
(12) Patent Application Publication
(10) Pub. No.: US 2026/0119255 A1
(43) Pub. Date: Apr. 30, 2026

(54) DATA PROCESSING SYSTEM FOR AUTOMATIC PROCESSING OF CONTINUOUS FLOWS OR BATCH DATA

(71) Applicant: Ab Initio Technology LLC, Lexington, MA (US)

(72) Inventor: Joseph Skeffington Wholey, III, Belmont, MA (US)

(73) Assignee: Ab Initio Technology LLC, Lexington, MA (US)

(21) Appl. No.: 19/373,041

(22) Filed: Oct. 29, 2025

Related U.S. Application Data
(60) Provisional application No. 63/713,982, filed on Oct. 30, 2024.

(51) Int. Cl. G06F 9/50

(52) U.S. Cl. CPC G06F 9/5027

(57) ABSTRACT

Techniques for executing a data processing application in an environment in which there can be a plurality of data sources including continuous data sources and batch data sources. A data processing application may be representable as a plurality of input nodes and a plurality of processing nodes. The techniques include: for a node of the plurality of processing nodes having a first input configured at the time of execution of the application to receive batch data and a second input configured to receive continuous data: computing first data by executing data processing operations of the data processing application between the first input of the node and one or more data sources of the plurality of data sources on data from the one or more data sources; and storing the first data; and configuring the data processing system to, when executing the data processing application, use the stored first data as the first input to the node.

### CROSS REFERENCE TO RELATED APPLICATIONS

This application claims priority to and the benefit of U.S. Provisional Patent Application No. 63/713,982, filed on Oct. 30, 2024, entitled “DATA PROCESSING SYSTEM FOR AUTOMATIC PROCESSING OF CONTINUOUS FLOWS OR BATCH DATA,” which is incorporated by reference herein in its entirety.

### FIELD

The disclosure herein relates to a data processing systems and methods performed by the data processing systems that automatically adapt execution of a data processing application based on whether the types of input data sources are the same or different.

### BACKGROUND

Modern data processing systems manage vast amounts of data (e.g., millions, billions, or trillions of data records) and manage how these data may be accessed (e.g., created, updated, read, or deleted). A large institution (e.g., a multinational bank, global technology company, etc.) may have millions of datasets. For example, the datasets may store transaction records, documents, tables, files, or any other suitable type of data. The data sets can be batch data that is stored in memory and has a finite beginning and finite end (e.g., data stored in files) or continuous data that is a stream of data values (e.g., data in queues and Kafka event streams), which may have no predefined ending and may be generated in response to events.

A data processing system may store “metadata,” which is data that contains information about other data (e.g., stored in the same data processing system and/or another data processing system) and/or processes (e.g., in the same data processing system and/or another data processing system). For example, a data processing system may store metadata about data stored in a table or obtained from a continuous source. Non-limiting examples of such metadata include information indicating that the data source is a continuous data source or a batch data source. Metadata may also include, for batch data stored in a table for example, the size of the table in memory, when the table was created, when the table was last updated, the number of rows and/or columns in the table, where the table is stored, who has permission to read, update, delete and/or perform any other suitable action(s) with respect to the table.

A data processing system may execute data processing applications to support various functions. Data processing applications may be used to provide functions that support processes of an institution. The data processing applications may perform operations on datasets as part of executing such functions. For example, data processing applications may perform operations on batch data, such as a database of sensors or customers of an enterprise, or continuous data, such as measurements output by the sensors or transactions performed by the customers.

Typically, different data processing applications are written to process batch and continuous data. A developer writes code for the different data processing applications based on the type of data they are designed to process. For example, a developer writes code for a first data processing application designed to process batch data and code for a second data processing application designed to process continuous data. The code for the different data processing applications has to be maintained across different environments that the data processing system operates in (e.g., development, test, and production environments). Maintaining, compiling and executing multiple different data processing applications across different environments requires significant computing resources, such as storage or processing resources.

### SUMMARY

Some embodiments provide a method, performed by a data processing system, for executing a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the method comprising: for a node of the plurality of processing nodes having a first input configured to receive batch data and a second input configured to receive continuous data: computing first data by executing data processing operations of the data processing application between the first input of the node and one or more data sources of the plurality of data sources on data from the one or more data sources; and storing the first data; and configuring the data processing system to, when executing the data processing application, use the stored first data as the first input to the node.

Some embodiments provide a data processing system configured to execute a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the data processing system configured to perform a method comprising: for a node of the plurality of processing nodes having a first input configured at the time of execution of the application to receive batch data and a second input configured to receive continuous data: computing first data by executing data processing operations of the data processing application between the first input of the node and one or more data sources of the plurality of data sources on data from the one or more data sources; and storing the first data; and configuring the data processing system to, when executing the data processing application, use the stored first data as the first input to the node.

Some embodiments provide at least one non-transitory computer-readable storage medium storing instructions, that when executed by at least one computer hardware processor, cause the at least one computer hardware processor to perform a method for executing a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the method comprising: for a node of the plurality of processing nodes having a first input configured at the time of execution of the application to receive batch data and a second input configured to receive continuous data: computing first data by executing data processing operations of the data processing application between the first input of the node and one or more data sources of the plurality of data sources on data from the one or more data sources; and storing the first data; and configuring the data processing system to, when executing the data processing application, use the stored first data as the first input to the node.

Some embodiments provide a method, performed by a data processing system, for executing a data processing application, the data processing application comprising one or more input nodes representing one or more input data sources, one or more output nodes representing one or more output data stores, and a plurality of nodes representing a sequence of data processing operations to be performed on data, the method comprising: determining whether at least a first input data source of the one or more input data sources of the data processing application is a continuous input data source; based on determining that the first input data source of the one or more input data sources is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application.

Some embodiments provide a data processing system configured to execute a data processing application, the data processing application comprising one or more input nodes representing one or more input data sources, one or more output nodes representing one or more output data stores, and a plurality of nodes representing a sequence of data processing operations to be performed on data, the data processing system configured to perform a method comprising: determining whether at least a first input data source of the one or more input data sources of the data processing application is a continuous input data source; based on determining that the first input data source of the one or more input data sources is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application.

Some embodiments provide at least one non-transitory computer-readable storage medium storing instructions, that when executed by at least one computer hardware processor, cause the at least one computer hardware processor to perform a method for executing a data processing application, the data processing application comprising one or more input nodes representing one or more input data sources, one or more output nodes representing one or more output data stores, and a plurality of nodes representing a sequence of data processing operations to be performed on data, the method comprising: determining whether at least a first input data source of the one or more input data sources of the data processing application is a continuous input data source; based on determining that the first input data source of the one or more input data sources is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application.

Some embodiments provide a method, performed by a data processing system, for executing a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the method comprising: at a first time for execution of the data processing application when the plurality of input data sources of the data processing application are batch input data sources, executing the data processing application to perform operations on batch data; and at a second time for execution of the data processing application when at least a first input data source of the plurality of input data sources of the data processing application is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application at the second time.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is a schematic diagram of an example enterprise IT system including a data processing system, according to some embodiments of the technology described herein.

FIG. 2 is a schematic diagram of an example software application program development user interface (UI) of a data processing system, according to some embodiments of the technology described herein.

FIG. 3 is a schematic diagram of an example software application program development user interface (UI) showing a data processing application developed as a dataflow graph that processes batch data, according to some embodiments of the technology described herein.

FIGS. 4A and 4B are flowcharts of an illustrative process for managing a data processing application including at least one multi-input node configured to receive batch data and continuous data, according to some embodiments of the technology described herein.

FIGS. 5A-5C are schematic diagrams showing example implementation of a data processing application in a production environment, according to some embodiments of the technology described herein.

FIG. 6 is a block diagram of an illustrative computing system environment that may be used in implementing some aspects of the technology described herein.

### DETAILED DESCRIPTION OF INVENTION

Drawbacks with maintaining different data processing applications as discussed in the background section above, may be overcome with techniques that enable a data processing system to automatically adapt execution of a single data processing application based on whether one or more input sources are of the same type or of different types. In particular, the techniques as described herein enable a data processing system to automatically adapt execution of a data processing application based on whether one or more input data sources are batch data sources or continuous data flows. The data processing system may dynamically identify data sources that provide a continuous flow (referred to herein as continuous sources) and then identify operations within the data processing application in which batch data and data formatted as a continuous flow are co-processed. Data representative of the batch data at the input of the identified operation may be stored. Upon execution of the identified operation, the data processing system may substitute the stored data for the data formatted as the batch input for performing the identified operation in combination with the continuous flow.

The identified operations may be join operations, for example, that have a first input coupled, directly or indirectly, only to batch data sources and a second input coupled, directly or indirectly, to a data source providing a continuous data flow. The stored data may include records, representative of data from the batch data source as processed at operations within the application between the point at which data is derived from the batch data source and the second input of the identified operation. For a join operation, the stored data may be organized based on one or more keys to the join operation. For example, the stored data may include records associated with unique join key(s). Optionally, fields from the batch data that are not output from the join operation may be omitted from the stored data and/or the stored data may be formatted for efficient processing in other ways, such as sorting by join key(s) or in other ways.

Optionally, the stored data may be refreshed. For example, the stored data may be replaced with data generated from data in the batch data sources at a later point in time. The stored data, for example, may be refreshed daily at the same time.

Such a data processing system may enable a user to define a single data processing application independent of data sources to be used when the application is executed. For execution, the data sources may be identified, without regard to the type of the data source. The system may automatically associate data sources, regardless of type, with the application and, using techniques described herein, prepare an appropriate executable form of the application.

Optionally, automatic identification of a type of data source, such as batch or continuous, may be based on runtime information. A data processing application, for example, may be configured to operate in conjunction with a data source that is defined logically rather than as a specific physical data source. The data processing system may, at execution time for the application, access a physical data source correlated to the logically defined data source. A catalog linking physical data sources to logically defined data sources may be used for this purpose, for example.

Once the data processing system resolves the appropriate physical data sources, the application may be prepared for execution. Data sources that are continuous might be identified and operations within the application that have inputs formatted as both batch data and continuous flows of data may be identified. Data stores for use in place of the batch data input to those operations may then be created as described herein.

As an application can be defined independently of the types of data sources to be accessed, the application can be more simply prepared and updated. Multiple applications with different processing steps applicable for different types of data sources, for example, may be omitted. In addition to simplifying the creation and/or updating of data processing applications, reductions in computer resources for storage and selecting the appropriate set of processing steps may be facilitated.

Moreover, a data processing system with the capability to automatically adapt execution of a data processing application based on the type of data sources specified as inputs to the application may enable different types of data sources to be used at different times in the lifecycle of the application. A substantial reduction in computing resources, such as storage or processing, might be achieved by adapting execution of a data processing application written to process data that is available from a continuous source(s) for use with stored data (rather than data formatted as a continuous flow). An application, for example, might be developed and/or tested using batch data sources for efficiency, but be intended for execution with one or more continuous data flows. Using batch mode data sources, for example, may be simpler, take less time, computer processing power, or computer memory and/or may deliver consistent results because variations in content or synchronization of data in the continuous data flow do not impact the results of execution of the data processing application. In later stages of the application lifecycle, continuous data sources might be substituted for one or more of the batch data sources. The application might nonetheless operate as expected when executed by a data processing system configured for execution of either batch or continuous data sources as described herein.

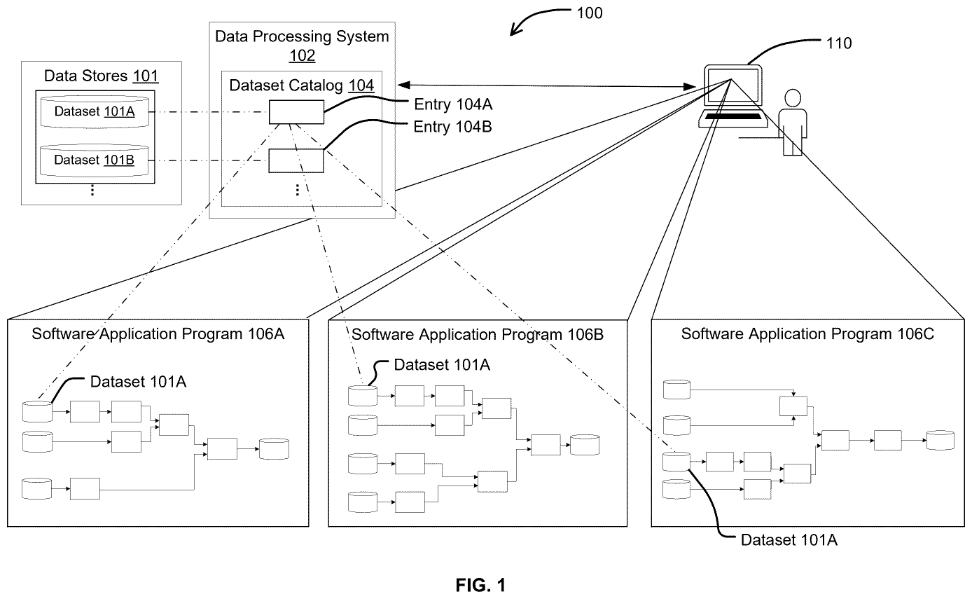

FIG. 1 is a diagram of an enterprise IT system 100. As shown in FIG. 1, the enterprise IT system 100 includes a data processing system 102 configured to access (e.g., read data from and/or write data) data stores 101. A data store from which the data processing system 102 may be configured to read data may be referred to as a data source. A data store to which the data processing system 102 may be configured to write data may be referred to as a data sink. In some embodiments, a data source may store datasets including dataset 101A, 101B. In this example, datasets 101A and 101B are physical datasets, and each may represent batch data, which is already stored in memory, or a continuous flow that is generated over time. The continuous flow, for example, may come from a point of sale system in a retail enterprise with each transaction generating a record in the continuous flow. The data processing system 100 includes a dataset catalog 104 with entries connecting logical data sources and physical datasets stored in data stores 101 that may be accessed in connection with execution of an application containing operations specified to be performed on the logical data sources. The entries include entry 104A corresponding to dataset 101A and entry 104B corresponding to dataset 101B. A user of device 110 may develop data processing applications in the data processing system 102 that perform operations using datasets stored in the data stores 101. The data processing applications may be developed as dataflow graphs. FIG. 1 shows data processing applications 106A, 106B, 106C that have been developed by the user. The data processing applications 106A, 106B, 106C operate on input datasets.

The entries 104A, 104B in the dataset catalog 104 may be used to incorporate a dataset into a data processing application. The user of device 110 may use the entries 104A, 104B to associate datasets 101A, 101B with input data sources in a dataflow graph. As shown in the example of FIG. 1, dataset 101A has been included as an input in each of the data processing applications 106A, 106B, 106C using the entry 104A of the dataset catalog 104. Each of the data processing applications 106A, 106B, 106C performs one or more operations using data from the dataset 101A. When one of the data processing applications 106A, 106B, 106C is executed by the data processing system 100, the data processing system 100 may execute a set of operations indicated by a dataflow graph of the data processing application using data from the dataset 101A. The data processing system 100 may generate output data as a result of executing the data processing application.

In some embodiments, datasets 101A, 101B are physical datasets and the data processing application is written in terms of logical datasets corresponding to these physical datasets. In some embodiments, the entries 104A, 104B in the dataset catalog 104 provide information for accessing portions of the data stores 101 in which the physical datasets 101A, 101B represented by the logical datasets are stored. Examples of data processing applications for accessing physical datasets using entries in a dataset catalog corresponding to logical datasets are described in U.S. Patent Application Publication No. 2022/0245125, titled “Data Multiplexer for Data Processing System,” which is incorporated by reference herein in its entirety.

The data processing system 102 may have a large number (e.g., hundreds or thousands) of data processing applications developed as dataflow graphs to perform data processing using dynamic datasets managed by the data processing system. Further, users may frequently develop new dataflow graphs for new data processing applications. For example, the data processing system 102 may be used to manage datasets for a multinational bank. The multinational bank may develop thousands of dataflow graphs for processing customer data related to millions of bank accounts. In another example, the data processing system 100 may manage datasets for a credit card company. The credit card company may develop thousands of dataflow graphs for processing transaction data generated from millions of credit card transactions that occur per day.

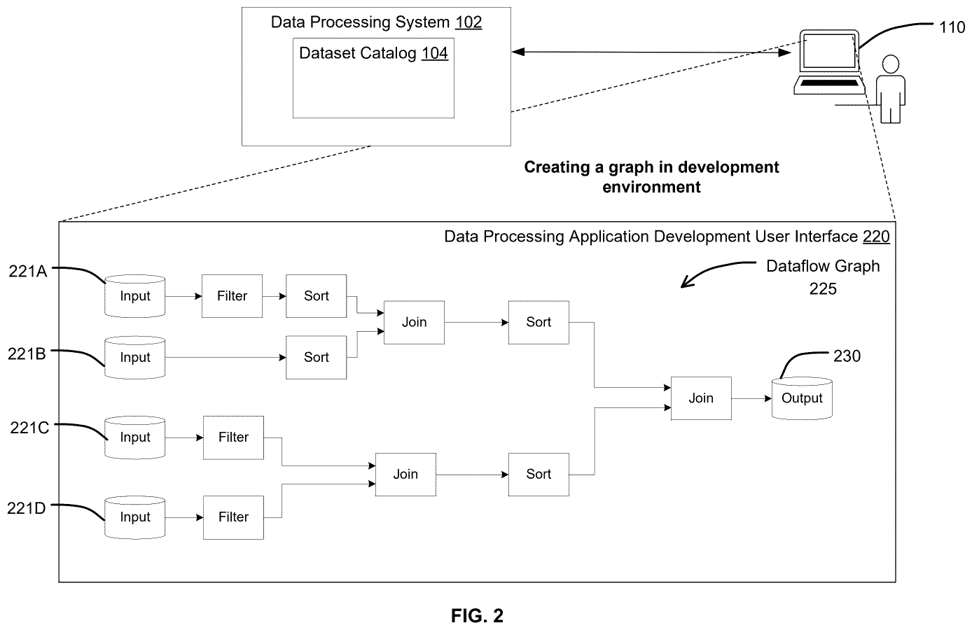

Data processing applications 106A, 106B, 106C may be defined with a control flow and a data flow. The control flow may specify operations to be performed as part of the execution of the application. The data flow may specify a sequence in which data is processed in these operations. As an example, the applications may be developed as data flow graphs, as shown in FIG. 2, for example. A dataflow graph may include components, termed “nodes” or “vertices,” representing data processing operations to be performed on data and links between the components representing flows of data. Techniques for executing computations encoded by dataflow graphs are described in U.S. Pat. No. 5,966,072, titled “Executing Computations Expressed as Graphs,” which is incorporated by reference herein in its entirety. An environment for developing applications (e.g., computer programs) as data flow graphs is described in U.S. Pat. Pub. No.: 2007/0011668, titled “Managing Parameters for Graph-Based Applications,” which is incorporated by reference herein in its entirety. The dataflow graph may include data sources (such as input data stores 221A, 221B, 221C, 221D, FIG. 2) and data sinks (such as output data store 230, FIG. 2).

FIG. 2 is a data processing application development UI 220 of the data processing system 100 shown on a display of a device 110 interacting with the data processing system 100, according to some embodiments of the technology described herein. The data processing application development UI 220 displays a dataflow graph 225 of a data processing application. As shown in FIG. 2, the data processing application receives data from multiple input nodes 221A, 221B, 221C, 221D, and performs various data processing operations (e.g., filter, sort, join, etc.) indicated at the nodes of the dataflow graph 225 to generate data at an output node 230 corresponding to an output data store. The data processing application development UI 220 may be used by a user of the device 110 to generate the dataflow graph 225. In some embodiments, the dataflow graph 225 may be automatically generated by the data processing system 102. For example, the dataflow graph 225 may be generated by the data processing system 102 based on a query input by the user.

Data processing applications may operate on different types of data. For example, data processing applications may include operations that process batch data (e.g., data stored in files and databases) and continuous data (e.g., data in queues and Kafka event streams). As an example, within a retail enterprise, sales data may arrive at a central office in real time, such that it may be regarded as continuous. That continuous flow of sales data may be an input data source for a data processing application. Such an input data source may be regarded as a continuous input data source. Additionally, within the enterprise the sales data may be cleaned or otherwise processed and some or all of it may be stored in a database. This database may serve as the input data source for the data processing applications. That database may be regarded as a batch input data source.

An enterprise may operate a data processing system in development, test, and production environments. The datasets used by a same data processing application managed by the data processing system may differ in each of these environments. For example, a physical dataset associated with a batch input data source may be used by the data processing application in a development environment whereas a different physical dataset associated with a continuous input data source (e.g., producing live data) may be used by the data processing application in a production environment.

The inventor has recognized that when a data processing application operates in different environments, it is helpful to enable a user to specify the data processing application (e.g., dataflow graph) without regard to whether it is operating on a continuous input or batch input data source. A dataflow graph, for example, may be intended for use in a production environment on a continuous input data source, but, for ease and repeatability of testing and development, may be operate on a batch input data source in development or test environments. Techniques as described herein enable seamless execution of the dataflow graph in development, test or production requirements regardless of the type of data source. For instance, the dataflow graph processes batch data when operating in the development or test environments and processes continuous data when operating in the production environment. Seamless execution of the dataflow graph is achieved by modifying the implementation of the dataflow graph based on the type of data source and/or environment. As one example, joins in the dataflow graph may be implemented differently based on the type of data source and/or environment. For instance, when operating on continuous input data sources in a production environment, joins may be implemented as a lookup, which reduces the time needed to process data.

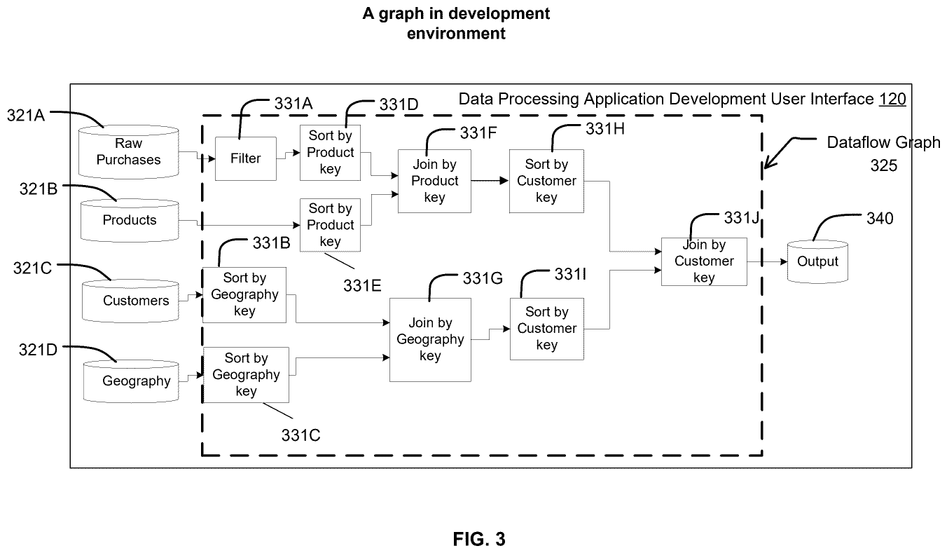

As shown in FIG. 3, in a development environment, a data processing application may operate on batch data. For example, dataflow graph 325 uses a physical dataset associated with a batch input source corresponding to “Raw Purchases” including information regarding purchases made by customers for various enterprise products, a second physical dataset associated with a batch input source corresponding to “Products” including information regarding products offered by the enterprise, a third physical dataset associated with a batch input source corresponding to “Customers” including information regarding the enterprise's customers, and a fourth physical dataset associated with a batch input source corresponding to “Geography” including information regarding the various geographical locations of retails stores where the purchases are made. Dataflow graph 325 may include one or more input nodes 321A, 321B, 321C, 321D representing the input data sources, one or more processing nodes 331A, 331B, 331C, 331D, 331E, 331F, 331G, 331H, 331I, 331J representing data processing operations (e.g., filter, sort, join, etc.) to be performed on data and relative ordering of the data processing operations performed on the data, and one or more output nodes 340 representing output data stores configured to store results of the data processing operations performed on the data. In the development environment, the dataflow graph 325 may process batch data from batch input data sources (e.g., files, databases, etc.).

In the production environment, at least some of the data to be processed by the same dataflow graph 325 may include continuous data in addition to batch data. The continuous data may be live data that is used in the production environment and may not be used in either development or test environments to avoid corruption of the live data and/or minimize the risk of exposing sensitive information. In some embodiments, entries in the dataset catalog 104 may store information for accessing datasets in the development, test, and production environments. For example, an entry corresponding to a dataset may store information indicating whether an input data source associated with the dataset is associated with a batch input data source or a continuous input data source, which environment (e.g., development, test, or production) the dataset is to be used in, and/or other information regarding accessing the dataset.

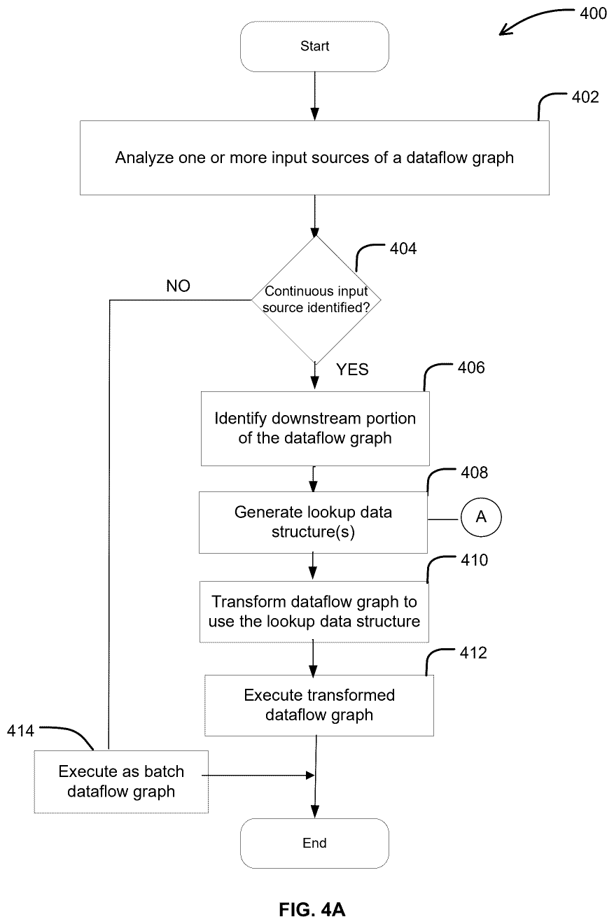

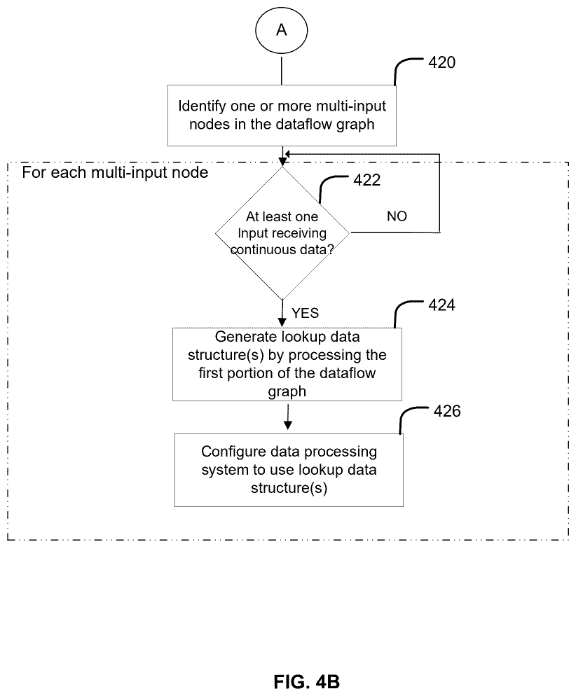

FIGS. 4A-4B are flowcharts of an illustrative process 400 for executing (such as by the data processing system) a data processing application. When executed, the data processing system may determine that the graph as set up for execution includes at least one multi-input node configured to receive batch data and continuous data, according to some embodiments of the technology described herein. Process 400 may be executed by data processing system 100 described in reference to FIG. 1. Process 400 may alternatively or additionally include other acts, including acts as described elsewhere herein in connection with other embodiments. In some embodiments, process 400 may be performed in response to a request to execute the data processing application, in a production environment, for example. Prior to execution, a user, such as in the development environment, may specify for each input node a dataset (e.g., a logical dataset) from which data is to be read. To enable the data processing application to execute, the data processing system may relate the logical dataset to information that enables read and write operations to be performed on the physical datasets corresponding to the logical datasets at the time the application is executed. This may be done by obtaining information from the dataset catalog 104.

Process 400 may begin at act 402, where one or more input data sources of a data processing application (e.g., dataflow graph 325) may be analyzed. The analysis may be performed to identify, for each of the input data sources, whether the input data source is a batch input data source or a continuous input data source. In some embodiments, this identification may be performed by analyzing the information stored in the dataset catalog 104 relating to the logical/physical datasets associated with the input data sources. In some examples, all of the continuous data sources from which the application is configured to obtain data may be identified, expressly or implicitly, such that they may be addressed as subsequent subprocess of identifying operations in the application that include batch input and a continuous input.

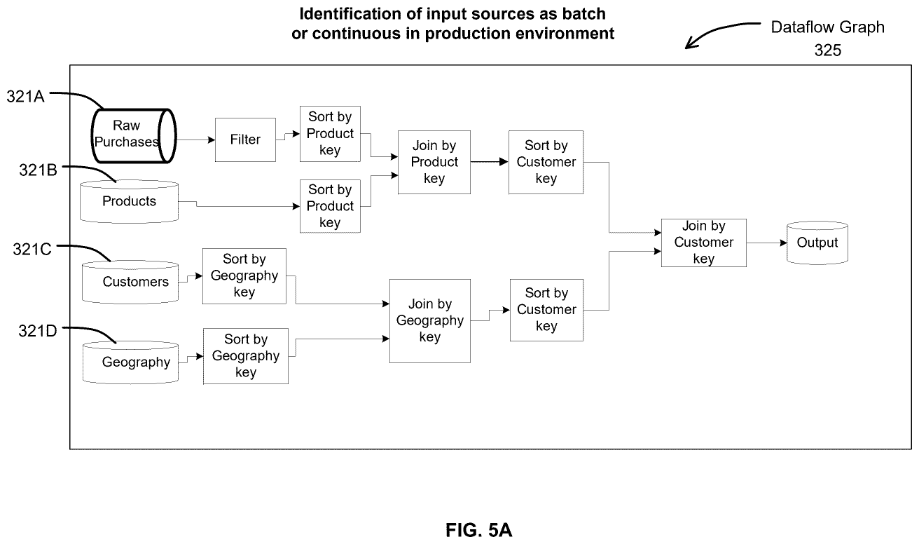

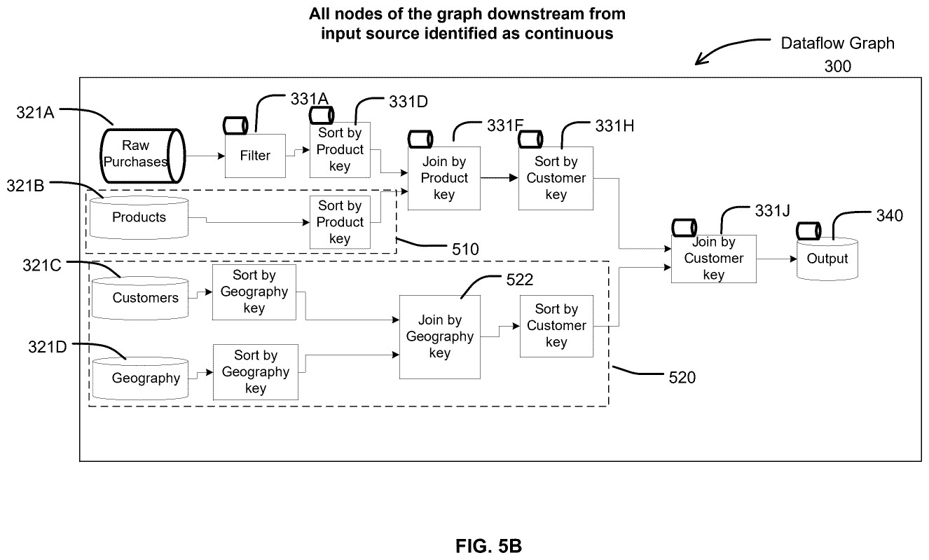

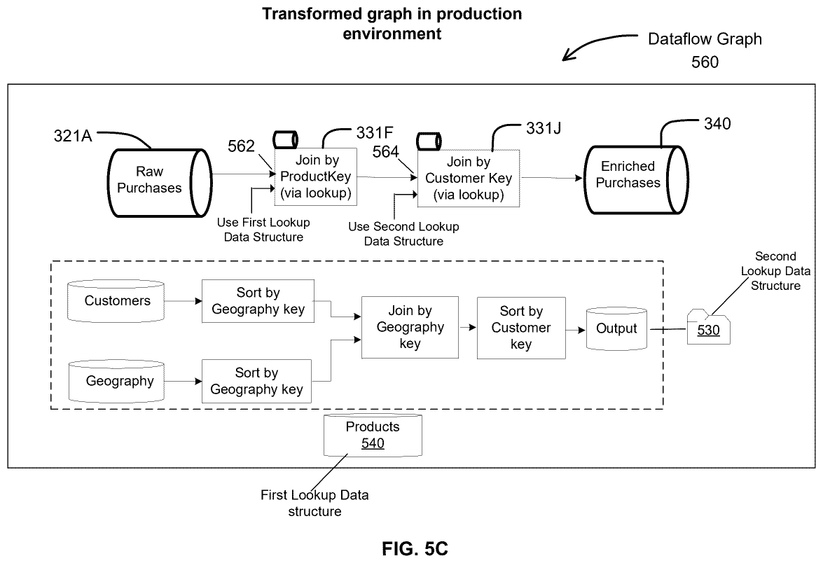

At act 404, a determination is made regarding whether at least a first input data source of the one or more input data sources of the data processing application is a continuous input data source. For example, as shown in FIG. 5A, the input data source represented by input node 321A may be identified as a continuous input data source. Based on determining that a first input data source of the one or more input data sources is a continuous input data source, process 400 proceeds to act 406 where a downstream portion of the data processing application may be identified. The downstream portion is a portion of the dataflow graph 325 that is downstream from the continuous input data source, where the downstream portion is configured to operate on continuous data originating from the continuous input data source. As shown in FIG. 5B, a portion of the dataflow graph including nodes 331A, 331D, 331F, 331H, 331J, and 340 may be identified as the downstream portion of the dataflow graph 325. In the example illustrated, the downstream portion may end at a node that has multiple inputs, with a batch input in addition to the continuous input. Nodes that have multiple inputs that are all continuous, however, may be included in the downstream portion.

In some embodiments, identifying a downstream portion of the data processing application may include storing, in a data store, one or more labels identifying one or more nodes of the data processing application downstream from the continuous input data source as continuous components. As shown in FIG. 5B, nodes 331A, 331D, 331F, 331H, 331J, and 340 may be identified as continuous components. Alternatively or additionally, the nodes in the downstream portion may be identified by implication, such as by identifying the nodes terminating the relevant downstream portion.

A data structure may be generated for nodes terminating a downstream portion. In the illustrated example, a data structure is generated for each node terminating a downstream portion of any of the continuous data sources, but techniques as described herein may be applied with one or more such nodes.

At act 408, one or more lookup data structures may be generated. In some embodiments, for a first node in the downstream portion of the data processing application that represents an operation to be performed on the continuous data originating from at least one continuous input data source and batch data originating from at least one batch input data source, a first lookup data structure may be generated. The first lookup data structure may be generated by processing a first portion of the data processing application that is configured to operate on the batch data originating from the batch input data source. For example, as shown in FIG. 5B, node 331F represents a join operation to be performed on continuous data originating from the continuous input data source represented by input node 321A and batch data originating from a batch input data source represented by input node 321B. A first lookup data structure, such as database 540 shown in FIG. 5C, may be generated by processing a portion 510 of the data processing application that is configured to operate on the batch data.

The lookup may be stored in a format in which data available to complete the multi-input operation is retained throughout the execution of the application. The lookup, for example, may be stored as a file such that data from the lookup may be accessed with a simple read command from the file. Alternatively or additionally, a lookup may be stored in a database such that the appropriate data is accessed with a query on the database, but in other examples, other persistent data organization techniques may be used to implement a lookup.

In some embodiments, generating the first lookup data structure may include identifying one or more nodes of the data processing application upstream from the first node that are configured to operate on the batch data originating from the batch input data source, and generating the first lookup data structure by processing the one or more nodes upstream from the first node.

In some embodiments, for a second node in the downstream portion of the data processing application that represents an operation to be performed on the continuous data originating from the continuous input data source and batch data originating from a second batch input data source, a second lookup data structure may be generated. The second lookup data structure may be generated by processing a second portion of the data processing application that is configured to operate on the batch data originating from the second batch input data source. For example, as shown in FIG. 5B, node 331J represents a join operation to be performed on continuous data originating from at least one continuous input data source represented by input node 321A and batch data originating from at least one batch input data source represented by input nodes 321C, 321D. A second lookup data structure, such as file 530 shown in FIG. 5C, may be generated by processing a portion 520 of the data processing application that is configured to operate on the batch data.

At act 410, the data processing application may be transformed to use the lookup data structure(s). In some embodiments, transforming the data processing application includes configuring the first node representing the operation to use the first lookup data structure as input during execution of the data processing application. In some embodiments, transforming the data processing application includes configuring the second node representing the operation to use the second lookup data structure as input during execution of the data processing application.

FIG. 5C shows an example transformed data processing application 560 in a production environment. The transformed data processing application is configured to process live continuous data originating from a continuous input data source represented by input node 321A. As shown in FIG. 5C, the transformed dataflow graph includes the multi-input nodes 331F and 331J representing join operations to be performed on the continuous data. Output node 340 represents an output data store configured to store results of the join operations performed on the continuous data.

The process then proceeds to act 412, where the transformed data processing application is executed. As each record in a continuous flow at the input of a multi-input operation is processed, the corresponding batch input for that operation may be obtained from the lookup. In the illustrated scenario in which the multi-input operations are joins, when the transformed dataflow graph is executed, the join operations are performed using the data stored in the first and second lookup data structures. Using the data stored in the first lookup data structure comprises, for each of a plurality of records of the continuous data at input 562 to node 331F, a field value in the continuous data may be used as a key to select a corresponding record in the first lookup data structure 540. Using the data stored in the second lookup data structure comprises, for each of a plurality of records of the continuous data at input 564 to node 331J, using a field value in the continuous data as a key to select a corresponding record in the second lookup data structure 530.

With such an execution approach, there may be batch data available for each record in the continuous data flow regardless of how many records of the continuous data flow are processed. Accordingly, the application can be executed without special processing to align or otherwise synchronize the continuous flow to the batch data. Alternatively or additionally, errors or unintended operating states may be avoided as a result of the batch data being fully processed before execution of the application with continuous data is stopped. Moreover, so long as the lookup is retained, repeated execution of the application can provide predictable results.

In some embodiments, based on determining that no input data source of the one or more input data sources is a continuous input data source, the process proceeds to act 414, where the data processing application may be executed without transformation. In other words, when all the input data sources of the data processing application are batch input data sources, the data processing application may be executed without transformation.

In some embodiments, generating one or more lookup data structures 530, 540 comprises acts 420, 422, 424, and 426 shown in FIG. 4B. At act 420, one or more multi-input nodes in the data processing application may be identified. Multi-input nodes are nodes having two or more inputs. For example, nodes 331F, 331J and 522, as shown in FIG. 5B, may be identified as multi-input nodes. Multi-input node 522 has a first input configured to receive batch data originating from a batch input data source represented by node 321C and a second input configured to receive batch data originating from a batch input data source represented by node 321D. Multi-input node 331F has a first input configured to receive batch data originating from a batch input data source represented by node 321B and a second input configured to receive continuous data originating from a continuous input data source represented by node 321A. Multi-input 331J has a first input configured to receive batch data originating from batch input data sources represented by node 321C and 321D and a second input configured to receive continuous data originating from a continuous input data source represented by node 321A and batch input data source represented by node 312B.

At act 422, a determination may be made regarding whether at least one of the inputs of each of the identified multi-input nodes is configured to receive continuous data originating from a continuous data source. At act 424, based on a determination that at least one of the inputs of a multi-input node is configured to receive continuous data originating from a continuous data source, a lookup data structure may be generated.

In some embodiments, based on a determination that at least one of the inputs of a first multi-input node is configured to receive continuous data originating from a continuous data source, a first lookup data structure may be generated. The first lookup data structure may be generated by processing the first portion 510 of the data processing application. In some embodiments, for a first node, such as multi-input node 331F having a first input configured to receive batch data originating from a batch input data source represented by node 321B and a second input configured to receive continuous data originating from a continuous input data source represented by node 321A, first data may be computed. First data may be computed by executing data processing operations of the data processing application between the first input of the node (e.g., node 331F) and one or more data sources (e.g., batch input data source 321B) on data from the one or more data sources. In some embodiments, the first data may be stored in the first lookup data structure (e.g., database 540). In some embodiments, the first node is configured to receive batch data by direct or indirect upstream connections within the data processing application only to batch input data sources.

In some embodiments, computing the first data may include identifying the first node by searching the data processing application for nodes having a first input coupled within the data processing application directly or indirectly to only upstream data sources that are batch input data sources and a second input coupled directly or indirectly to an upstream data source that is a continuous data source.

In some embodiments, in response to a determination that at least one of the inputs of a second multi-input node is configured to receive continuous data originating from a continuous data source, a second lookup data structure may be generated. The second lookup data structure may be generated by processing the second portion 520 of the data processing application. In some embodiments, for a second node, such as multi-input node 331J having a first input configured to receive batch data originating from a batch input data source represented by nodes 321C, 321D and a second input configured to receive continuous data originating from a continuous input data source represented by node 321A, second data may be computed. Second data may be computed by executing data processing operations of the data processing application between the first input of the node (e.g., node 331F) and one or more data sources (e.g., batch input data sources 321C, 321D) on data from the one or more data sources. In some embodiments, the second data may be stored in the second lookup data structure (for example, file 530).

In some embodiments, similar processing of data processing operations and generation of lookup data structures may be performed for every multi-input node identified as having at least one input that is configured to receive continuous data originating from a continuous data source.

At act 426, the data processing system may be configured to, when executing the data processing application, use the data stored in lookup data structures. In some embodiments, the data processing system may be configured to, when executing the data processing application, use the stored first data as the first input to the first node 331F and use the stored second data as the first input to the second node 331J.

In some embodiments, the process 400 described herein may be performed at a first time, where the first time comprises execution of the data processing application in a development or test environment. In this case, the process 400 is performed for execution of the data processing application when an upstream batch input data source is connected, through direct or indirect upstream connections within the data processing application, to an input of the multi-input node. During the first time, the data processing application is executed without transformation. Thereafter, the process 400 described herein may be performed at a second time after the first time, where the second time comprises execution of the data processing application in a production environment. In this case, the process 400 is performed for execution of the data processing application when an upstream continuous data source is connected instead of the upstream batch data source, through the direct or indirect upstream connections within the data processing application, to the input of the multi-input node. During the second time, one or more portions of the data processing application are transformed to process the continuous data. In some embodiments, the first time comprises execution of the data processing application on data for a finite time period and the second time comprises execution of the data processing application on data being generated in real time.

The inventor has recognized that data used for the lookups in the production environment optionally may be refreshed to avoid using stale data during execution of the data processing application. To this end, each of the one or more lookup data structures may be refreshed by processing the corresponding portions of the data processing application at a predefined schedule. For example, the first lookup data structure may be refreshed by processing the first portion 510 of the data processing application at a first predefined schedule and the second lookup data structure may be refreshed by processing the second portion 520 of the data processing application at a second predefined schedule, which may be the same as or different from the first predefined schedule.

According to some aspects, a method, performed by a data processing system, for executing a data processing application in an environment in which there can be a plurality of data sources including continuous data sources and batch data sources is provided. The data processing application is representable as a plurality of input nodes representing a plurality of input data sources and a plurality of processing nodes representing data processing operations to be performed on data and relative ordering of the data processing operations performed on data from data sources of the plurality of data sources. The method comprises for a node of the plurality of processing nodes having a first input configured to receive batch data and a second input configured to receive continuous data: computing first data by executing data processing operations of the data processing application between the first input of the node and one or more data sources of the plurality of data sources on data from the one or more data sources; and storing the first data; and configuring the data processing system to, when executing the data processing application, use the stored first data as the first input to the node.

According to some aspects, the stored first data as the first input to the node comprises, for each of a plurality of records of the continuous data at the second input to the node, using a field value in the continuous data as a key to select a corresponding record in the stored first data.

According to some aspects, the first node is configured to receive batch data by direct or indirect upstream connections within the data processing application only to batch data sources.

According to some aspects, storing the first data comprises storing the first data as a file.

According to some aspects, the one or more data sources are all batch data sources.

According to some aspects, computing first data comprises identifying the node by searching the data processing application for nodes having a first input coupled within the data processing application directly or indirectly to only upstream data sources that are batch data sources and a second input coupled directly or indirectly to an upstream data source that is a continuous data source.

According to some aspects, the node represents a join operation.

According to some aspects, the data processing application is formatted as a data flow graph.

According to some aspects, the acts of computing and storing are performed for each of a plurality of nodes of the data processing application having a first input configured to receive batch data and a second input configured to receive continuous data.

According to some aspects, the method is performed at a first time for execution of the data processing application when an upstream batch data source is connected, through direct or indirect upstream connections within the data processing application, to the second input; and the method is performed at a second time for execution of the data processing application when an upstream continuous data source is connected instead of the upstream batch data source, through the direct or indirect upstream connections within the data processing application, to the second input.

According to some aspects, the first time comprises execution of the data processing application in a development or test environment and the second time comprises execution of the data processing application in a production environment.

According to some aspects, the first time comprises execution of the data processing application on data for a finite time period and the second time comprises execution of the data processing application on data being generated in real time.

According to some aspects, a method, performed by a data processing system, for executing a data processing application is provided. The data processing application comprises one or more input nodes representing one or more input data sources, one or more output nodes representing one or more output data stores, and a plurality of nodes representing a sequence of data processing operations to be performed on data. The method comprises: determining whether at least a first input data source of the one or more input data sources of the data processing application is a continuous input data source; based on determining that the first input data source of the one or more input data sources is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application.

According to some aspects, identifying a downstream portion of the data processing application comprises: storing, in a data store, one or more labels identifying one or more nodes of the data processing application downstream from the continuous input data source as continuous components.

According to some aspects, generating the first lookup file by processing the first portion of the data processing application comprises: identifying one or more nodes of the data processing application upstream from the first node that are configured to operate on the batch data originating from the batch input data source; and generating the first lookup data structure by processing the one or more nodes upstream from the first node.

According to some aspects, the method comprises storing, in computer readable media, the first lookup data structure for use during execution of the data processing application.

According to some aspects, the method comprises for a second node in the downstream portion of the data processing application that represents an operation to be performed on the continuous data originating from the continuous input data source and batch data originating from a second batch input data source, generating a second lookup data structure by processing a second portion of the data processing application that is configured to operate on the batch data originating from the second batch input data source.

According to some aspects, transforming the data processing application further comprises: configuring the second node representing the operation to use the second lookup data structure as input during execution of the data processing application.

According to some aspects, determining whether the at least a first input data source of the one or more input data sources is a continuous input data source comprises: obtaining, from a dataset catalog storing parameters relating to input data sources, one or more parameters relating to the first input data source; and determining that the first input data source is a continuous data input source or a batch input data source based on the one or more parameters obtained from the dataset catalog.

According to some aspects, the data processing application is a dataflow graph.

According to some aspects, refreshing the first lookup data structure, wherein the refreshing comprises processing the first portion of the data processing application at a predefined schedule.

According to some aspects, the operation is a join operation.

According to some aspects, a data processing system configured to execute a data processing application in an environment in which there can be a plurality of data sources including continuous data sources and batch data sources is provided. The data processing application is representable as a plurality of input nodes representing a plurality of input data sources and a plurality of processing nodes representing data processing operations to be performed on data and relative ordering of the data processing operations performed on data from data sources of the plurality of data sources. The data processing system is configured to perform a method comprising: for a node of the plurality of processing nodes having a first input configured at the time of execution of the application to receive batch data and a second input configured to receive continuous data: computing first data by executing data processing operations of the data processing application between the first input of the node and one or more data sources of the plurality of data sources on data from the one or more data sources; and storing the first data; and configuring the data processing system to, when executing the data processing application, use the stored first data as the first input to the node.

According to some aspects, at least one non-transitory computer-readable storage medium storing instructions is provided, that when executed by at least one computer hardware processor, cause the at least one computer hardware processor to perform a method for executing a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the method comprising: for a node of the plurality of processing nodes having a first input configured at the time of execution of the application to receive batch data and a second input configured to receive continuous data: computing first data by executing data processing operations of the data processing application between the first input of the node and one or more data sources of the plurality of data sources on data from the one or more data sources; and storing the first data; and configuring the data processing system to, when executing the data processing application, use the stored first data as the first input to the node.

According to some aspects, a data processing system configured to execute a data processing application is provided, the data processing application comprising one or more input nodes representing one or more input data sources, one or more output nodes representing one or more output data stores, and a plurality of nodes representing a sequence of data processing operations to be performed on data, the data processing system configured to perform a method comprising: determining whether at least a first input data source of the one or more input data sources of the data processing application is a continuous input data source; based on determining that the first input data source of the one or more input data sources is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application.

According to some aspects, at least one non-transitory computer-readable storage medium storing instructions is provided, that when executed by at least one computer hardware processor, cause the at least one computer hardware processor to perform a method for executing a data processing application, the data processing application comprising one or more input nodes representing one or more input data sources, one or more output nodes representing one or more output data stores, and a plurality of nodes representing a sequence of data processing operations to be performed on data, the method comprising: determining whether at least a first input data source of the one or more input data sources of the data processing application is a continuous input data source; based on determining that the first input data source of the one or more input data sources is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application.

According to some aspects, a method, performed by a data processing system, for executing a data processing application in an environment in which there can be a plurality of data sources including continuous data sources and batch data sources is provided. The data processing application is representable as a plurality of input nodes representing a plurality of input data sources and a plurality of processing nodes representing data processing operations to be performed on data and relative ordering of the data processing operations performed on data from data sources of the plurality of data sources. The method comprises: at a first time for execution of the data processing application when the plurality of input data sources of the data processing application are batch input data sources, executing the data processing application to perform operations on batch data; and at a second time for execution of the data processing application when at least a first input data source of the plurality of input data sources of the data processing application is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application at the second time.

According to some aspects, a data processing system configured to execute a data processing application in an environment in which there can be a plurality of data sources including continuous data sources and batch data sources is provided. The data processing application is representable as a plurality of input nodes representing a plurality of input data sources and a plurality of processing nodes representing data processing operations to be performed on data and relative ordering of the data processing operations performed on data from data sources of the plurality of data sources. The data processing system is configured to perform a method comprising: at a first time for execution of the data processing application when the plurality of input data sources of the data processing application are batch input data sources, executing the data processing application to perform operations on batch data; and at a second time for execution of the data processing application when at least a first input data source of the plurality of input data sources of the data processing application is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application at the second time.

According to some aspects, According to some aspects, at least one non-transitory computer-readable storage medium storing instructions is provided, that when executed by at least one computer hardware processor, cause the at least one computer hardware processor to perform a method for executing a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the method comprising: at a first time for execution of the data processing application when the plurality of input data sources of the data processing application are batch input data sources, executing the data processing application to perform operations on batch data; and at a second time for execution of the data processing application when at least a first input data source of the plurality of input data sources of the data processing application is a continuous input data source: identifying a downstream portion of the data processing application, downstream from the continuous input data source, that is configured to operate on continuous data originating from the continuous input data source; and for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and transforming the data processing application, wherein the transforming comprises configuring the first node representing the operation to use the first lookup data structure as input during execution of the data processing application at the second time.

### Additional Implementation Details

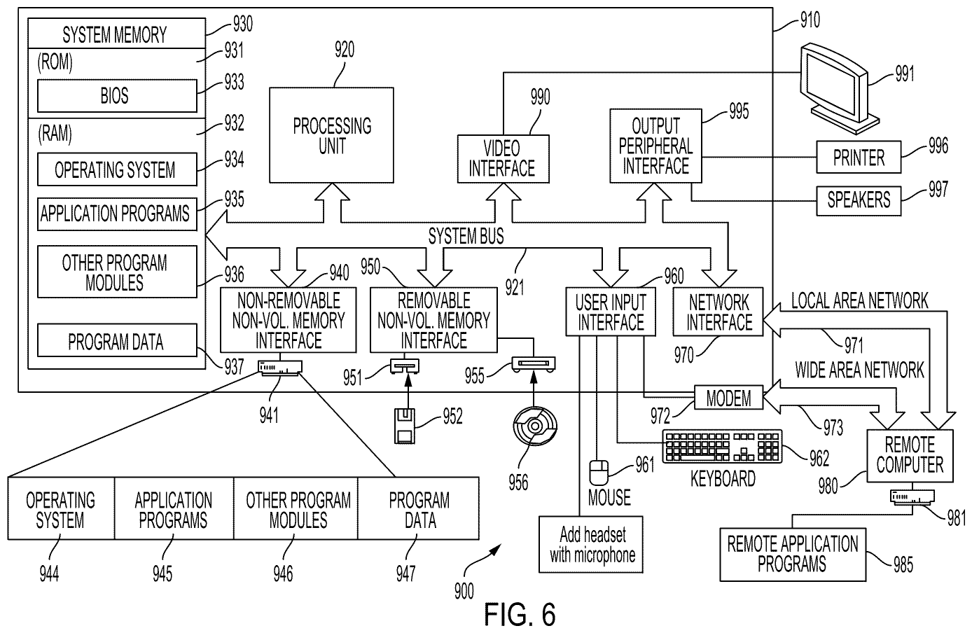

FIG. 6 illustrates an example of a suitable computing system environment 900 on which the technology described herein may be implemented. The computing system environment 900 is only one example of a suitable computing environment and is not intended to suggest any limitation as to the scope of use or functionality of the technology described herein. Neither should the computing environment 900 be interpreted as having any dependency or requirement relating to any one or combination of components illustrated in the exemplary operating environment 900.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the technology described herein includes a general purpose computing device in the form of a computer 900. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 6 illustrates operating system 934, application programs 935, other program modules 936, and program data 937.

The computer 910 may also include other removable/non-removable, volatile/nonvolatile computer storage media. By way of example only, FIG. 6 illustrates a hard disk drive 941 that reads from or writes to non-removable, nonvolatile magnetic media, a flash drive 951 that reads from or writes to a removable, nonvolatile memory 952 such as flash memory, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media described above and illustrated in FIG. 6, provide storage of computer readable instructions, data structures, program modules and other data for the computer 910. In FIG. 6, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. An actor may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 6. The logical connections depicted in FIG. 6 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the actor input interface 960, or other appropriate mechanism. In a networked environment, program modules depicted relative to the computer 910, or portions thereof, may be stored in the remote memory storage device. By way of example, and not limitation, FIG. 6 illustrates remote application programs 985 as residing on memory device 981. It will be appreciated that the network connections shown are exemplary and other means of establishing a communications link between the computers may be used.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

Having thus described several aspects of the technology described herein, it is to be appreciated that various alterations, modifications, and improvements are possible. Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described aspects of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions or processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIG. 8. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user”. It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A data processing system configured to execute a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the data processing system configured to perform a method comprising:
for a node of the plurality of processing nodes having a first input configured at the time of execution of the application to receive batch data and a second input configured to receive continuous data:
computing first data by executing data processing operations of the data processing application between the first input of the node and one or more data sources of the plurality of data sources on data from the one or more data sources; and
storing the first data; and
configuring the data processing system to, when executing the data processing application, use the stored first data as the first input to the node.

2. The data processing system of claim 1, wherein using the stored first data as the first input to the node comprises, for each of a plurality of records of the continuous data at the second input to the node, using a field value in the continuous data as a key to select a corresponding record in the stored first data.

3. The data processing system of claim 1, wherein the first node is configured to receive batch data by direct or indirect upstream connections within the data processing application only to batch data sources.

4. The data processing system of claim 1, wherein storing the first data comprises storing the first data as a file.

5. The data processing system of claim 1, wherein the one or more data sources are all batch data sources.

6. The data processing system of claim 1, wherein computing first data comprises identifying the node by searching the data processing application for nodes having a first input coupled within the data processing application directly or indirectly to only upstream data sources that are batch data sources and a second input coupled directly or indirectly to an upstream data source that is a continuous data source.

7. The data processing system of claim 1, wherein the node represents a join operation.

8. The data processing system of claim 1, wherein the data processing application is formatted as a data flow graph.

9. The data processing system of claim 1, wherein the acts of computing and storing are performed for each of a plurality of nodes of the data processing application having a first input configured to receive batch data and a second input configured to receive continuous data.

10. The data processing system of claim 1, wherein:
the method is performed at a first time for execution of the data processing application when an upstream batch data source is connected, through direct or indirect upstream connections within the data processing application, to the second input; and
the method is performed at a second time for execution of the data processing application when an upstream continuous data source is connected instead of the upstream batch data source, through the direct or indirect upstream connections within the data processing application, to the second input.

11. The data processing system of claim 10, wherein the first time comprises execution of the data processing application in a development or test environment.

12. The data processing system of claim 11, wherein the second time comprises execution of the data processing application in a production environment.

13. The data processing system of claim 10, wherein the first time comprises execution of the data processing application on data for a finite time period and the second time comprises execution of the data processing application on data being generated in real time.

14. A data processing system configured to execute a data processing application, the data processing application comprising one or more input nodes representing one or more input data sources, one or more output nodes representing one or more output data stores, and a plurality of nodes representing a sequence of data processing operations to be performed on data, the data processing system configured to perform a method comprising:
determining whether at least a first input data source of the one or more input data sources of the data processing application is a continuous input data source;
based on determining that the first input data source of the one or more input data sources is a continuous input data source:
identifying a downstream portion of the data processing application, downstream from the continuous input data source, that is configured to operate on continuous data originating from the continuous input data source; and
for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and
transforming the data processing application, wherein the transforming comprises configuring the first node representing the operation to use the first lookup data structure as input during execution of the data processing application.

15. The data processing system of claim 14, wherein identifying a downstream portion of the data processing application comprises:
storing, in a data store, one or more labels identifying one or more nodes of the data processing application downstream from the continuous input data source as continuous components.

16. The data processing system of claim 14, wherein generating the first lookup file by processing the first portion of the data processing application comprises:
identifying one or more nodes of the data processing application upstream from the first node that are configured to operate on the batch data originating from the batch input data source; and
generating the first lookup data structure by processing the one or more nodes upstream from the first node.

17. The data processing system of claim 14, wherein the method further comprises:
storing, in computer readable media, the first lookup data structure for use during execution of the data processing application.

18. The data processing system of claim 14, wherein the method further comprises:
for a second node in the downstream portion of the data processing application that represents an operation to be performed on the continuous data originating from the continuous input data source and batch data originating from a second batch input data source, generating a second lookup data structure by processing a second portion of the data processing application that is configured to operate on the batch data originating from the second batch input data source.

19. The data processing system of claim 18, wherein transforming the data processing application further comprises:
configuring the second node representing the operation to use the second lookup data structure as input during execution of the data processing application.

20. The data processing system of claim 14, wherein determining whether the at least a first input data source of the one or more input data sources is a continuous input data source comprises:
obtaining, from a dataset catalog storing parameters relating to input data sources, one or more parameters relating to the first input data source; and
determining that the first input data source is a continuous data input source or a batch input data source based on the one or more parameters obtained from the dataset catalog.

21. The data processing system of claim 14, wherein the data processing application is a dataflow graph.

22. The data processing system of claim 14, wherein the method further comprises:
refreshing the first lookup data structure, wherein the refreshing comprises processing the first portion of the data processing application at a predefined schedule.

23. The data processing system of claim 14, wherein the operation is a join operation.

24. A data processing system configured to execute a data processing application in an environment in which there can be a plurality of data sources including continuous data sources and batch data sources, the data processing application representable as a plurality of input nodes representing a plurality of input data sources and a plurality of processing nodes representing data processing operations to be performed on data and relative ordering of the data processing operations performed on data from data sources of the plurality of data sources, the data processing system configured to perform a method comprising:
at a first time for execution of the data processing application when the plurality of input data sources of the data processing application are batch input data sources, executing the data processing application to perform operations on batch data; and
at a second time for execution of the data processing application when at least a first input data source of the plurality of input data sources of the data processing application is a continuous input data source:
identifying a downstream portion of the data processing application, downstream from the continuous input data source, that is configured to operate on continuous data originating from the continuous input data source; and
for a first node in the downstream portion of the data processing application that represents an operation to be performed on the continuous data originating from the continuous input data source and batch data originating from a batch input data source, generating a first lookup data structure by processing a first portion of the data processing application that is configured to operate on the batch data originating from the batch input data source; and
transforming the data processing application, wherein the transforming comprises configuring the first node representing the operation to use the first lookup data structure as input during execution of the data processing application at the second time.
